(19) United States
(12) Patent Application Publication
(10) Pub. No.: US 2016/0174548 A1
(43) Pub. Date: Jun. 23, 2016

(54) AGROCHEMICAL FORMULATIONS WITH IMPROVED DRIFT CONTROL

(71) Applicant: LAMBERTI SPA, Albizzate (VA) (IT)

(72) Inventors: Valentina LANGELLA, Milano (VA) (IT); Mauro RICCABONI, Legnano (IT); Filippo QUAGLIA, Novate Milanese (MI) (IT); Giovanni FLORIDI, Novara (IT); Giuseppe LI BASSI, Gavirate (VA) (IT)

(21) Appl. No.: 14/911,206

(22) PCT Filed: Aug. 6, 2014
(86) PCT No.: PCT/EP2014/066927

§ 371 Date: Feb. 9, 2016

(30) Foreign Application Priority Data
Aug. 9, 2013 (IT) VA2013A000045

(51) Int. Cl. A01N 25/22; A01N 57/20; A01N 37/22; A01N 37/34

(52) U.S. Cl. CPC A01N 25/22; A01N 37/34; A01N 57/20; A01N 37/22

(57) ABSTRACT

The present invention relates to a process for the preparation of diluted agrochemical spray formations with improved drift control comprising the addition of a hydroxypropyl tamarind as drift control agent.

### TECHNICAL FIELD

The present invention relates to the process for the preparation of diluted agrochemical spray formulations with improved drift control comprising the addition of a hydroxypropyl tamarind as drift control agent. This invention pertains also to the use, as drift control agent, of a hydroxypropyl tamarind.

### BACKGROUND ART

The problem of “drift”, or “spray drift”, is well known in connection with the aerial spraying of water during the fire fighting operations and the spraying of aqueous compositions of agrochemicals, such as systemic herbicides, plant growth regulators, pesticides, insecticides, and the like. Spray drift is spray material that misses the target during application or moves off the target after application.

Spray drift is a restriction factor which reduces the efficiency of pesticide treatments, therefore it costs money through inefficient and off target application. It also increases the impact of chemicals on the environment and can adversely affect non-target plants.

Moreover spray drift can pollute adjacent water courses, groundwater, landscapes, and woodland. Drift can bring the applicator and members of the public into increased contact with potentially harmful or unpleasant chemicals.

Spray drift is caused by a combination of factors such as wind velocity, local atmospheric conditions, nozzle choice, sprayer pressure, vehicle speed, boom height and chemical factors.

Previous research has focused on reducing spray drift by altering the sprayer features, such as nozzles and pressure of the sprayer and by using spray adjuvants such as drift control agents to create larger droplets size.

The drift control agents (or anti-drift agent) change the visco-elastic properties of the spray liquid, more specifically by reducing its stretching capability (elongational viscosity) and its tendency to separate into smaller droplets. These factors result in coarser spray with a higher percentage of larger droplets and a lower percentage of smaller droplets, i.e. those having a diameter below 150 microns.

A number of drift control additives are commercially available.

Typical drift control agents are synthetic or natural polymers such as polyacrylamides, polyethylene oxides, polyvinyl pyrrolidones, guar gum and guar gum derivatives. In particular in the agriculture industry, polyacrylamides and guar gum and its derivatives are the standard tank additive for spray drift reduction.

Acrylamide polymers which give an optimum spray drift control are either the non-ionic homopolymer or anionic copolymer, both with a relatively low anionic content, i.e. 5 to 30% by weight of anionic monomer, and highly anionic.

Acrylamide (co)polymers are very good anti-drift agents, but unfortunately they tend to give too viscous aqueous solutions unless they are used at very low concentration. A normal field practice is to dissolve the polymer when in form of a powder or to reverse its phase emulsion when in form of an inverse latex by adding water and additive directly into the spray tank to get a polymer aqueous solution. However, this procedure has the problem that emulsion polymers can be difficult to activate in this situation and polymer powders take a long time to dissolve. This can lead to the formation of gel particles which can block in-line screens and nozzles, resulting in pressure buildup in the system and spotty spray patterns. In some cases it can be necessary to add more polymer as a result of inefficient dissolution of the same. Moreover acrylamide (co)polymers are essentially non-biodegradable and, therefore, it would be highly desirable to reduce their usage.

Also guar and derivatives of guar can be utilized in an aqueous spray medium as excellent drift control agents with essentially none of the above-identified disadvantages associated with the acrylamide polymers.

EP 0626724 describes a method for the preparation of an aqueous adjuvant concentrate with improved spray drift properties and comprising the steps of: i) dissolving from 15 to 30% by weight, on the weight of the final concentrate, of ammonium sulfate in water; ii) adding to the solution from 1 to 10% by weight, on the weight of the final concentrate, of anionic esters of alkyl polyglycosides; iii) dispersing in the solution from 2 to 10% by weight, on the weight of the final concentrate, of hydroxypropyl guar or hydroxypropyl guar acetate; iiii) adding ammonium sulfate to the dispersion to reach an ammonium sulfate final concentration comprised between 33 and 40% by weight.

US 2009/298,695 describes a substantially dry, flowable adjuvant compositions comprising, based on 100 parts by weight (“pbw”) of the adjuvant composition: (a) from about 25 pbw to about 75 pbw of a polysaccharide and (b) from about 75 pbw to about 20 pbw of a salt composition. In one embodiment, the polysaccharide is a derivatized guar.

WO 00/16630 provides an aqueous composition useful as a diluent for pesticide concentrates, said composition consisting essentially of a mixture of purified water having 1 to about 100 ppm total dissolved solids and a water dispersible polymer at a concentration of about 0.075 to about 0.2% by weight per unit volume. The preferred water dispersible polymers are optionally derivatized polygalactomannans.

US 2007/161512 relates to an aqueous agricultural pesticide composition, comprising:
(a) one or more water soluble or water dispersible deposition control agent, in an amount effective to provide improved anti-rebound properties;
(b) an effective amount of a pesticide.

The deposition agent can be chosen among various polysaccharides, for example tamarind gum.

WO 2011/128236 relates to a process for the preparation of diluted agrochemical spray formulations with improved drift control comprising a hydrophobically modified hydroxypropyl guar drift control agent and the use in agriculture of said spray formulations.

EP 0130385 relates to a thickening agent comprising a hydroxyalkylated-carboxymethylated tamarind seed powder or tamarind gum suitable for a printing paste or binding paste. In the document aqueous compositions comprising 1.5-3% by weight of hydroxypropyl carboxymethyl tamarind are exemplified.

None of the above mentioned documents describes hydroxypropyl tamarind as drift control agent in pesticide formulations.

We have now surprisingly discovered that a drift control agent, based on a hydroxypropyl tamarind (HP Tamarind), can be utilized in an aqueous spray medium providing excellent drift control performances.

The HP tamarind of the invention does not show the above-identified disadvantages associated with current usage of the polyacrylamide agents.

In addition, being a galactoxyloglucan derivative, HP tamarind is more stable in extreme solution conditions, for example low pH and high temperature, compared to guar. At the same time it represents an economically attractive substitute to guar and guar derivatives as antidrift agent.

The expression “hydroxypropyl molar substitution” (MS) means the average number of moles of hydroxypropyl groups for each anhydroglycosidic unit of the tamarind and can be measured, for example, by ¹H-NMR.

With the expression “hydrophobic degree of substitution” (DS_{H}), we mean the average number hydrophobic substituent on each anhydroglycosidic unit of tamarind, usually measured by means of gas chromatography or ¹H-NMR.

In the present text, with the expression “carboxyalkyl degree of substitution” (DS), we mean the average number of hydroxyl groups substituted with a carboxyalkyl group on each anhydroglycosidic unit of tamarind, which can be determined, for example, by means of ¹H-NMR or by titration.

### DESCRIPTION OF THE INVENTION

It is therefore an object of the present invention a process for the preparation of diluted agrochemical spray formulations with improved drift properties, comprising the addition of from 0.05 to 1.00% by weight (% wt) of a hydroxypropyl tamarind.

In an another aspect, the present invention is directed to the use of a hydroxypropyl tamarind water as spray drift control agent.

The characteristics and advantages related to the use of a hydroxypropyl tamarind as drift control agent according to the present invention are illustrated in detail in the following description.

### DESCRIPTION OF THE DRAWINGS

FIG. 1. Scheme of the apparatus for the spray drift tests

### DETAILED DESCRIPTION OF THE INVENTION

The process for preparing diluted agrochemical spray formulations having improved spray drift properties applies to any agrochemical composition which can contains, as active ingredients, pesticides or crop protection agents including herbicides, fungicides, insecticides, plant growth regulators, fertilizer, and mixture thereof.

The pesticides or crop protection agents utilisable in the agrochemical compositions of the invention are, by way of example: abamectin, acephate, acequinocyl, acetamiprid, acethion, acetoprole, acrinathrin, acrylonitrile, alanycarb, aldicarb, aldoxycarb, aldrin, allethrin, allosamidin, allyxycarb, alpha-cyperm ethrin, alpha-ecdysone, am idith ion, amidoflumet, aminocarb, amiton, amitraz, anabasine, arsenous oxide, athidathion, azadirachtin, azamethiphos, azinphos-ethyl, azinphos-methyl, azobenzene, azocyclotin, azothoate, barium hexafluorosilicate, barthrin, benclothiaz, bendiocarb, benfuracarb, benomyl, benoxafos, bensultap, benzoximate, benzyl benzoate, beta-cyfluthrin, beta-cypermethrin, bifenazate, bifenthrin, binapacryl, bioallethrin, bioethanomethrin, biopermethrin, bistrifluron, borax, boric acid, bromfenvinfos, bromo-DDT, bromoeyclen, bromophos, bromophos-ethyl, bromopropylate, bufencarb, buprofezin, butacarb, butathiofos, butocarboxim, butonate, butoxycarboxim, cadusafos, calcium arsenate, calcium polysulfide, campheehlor, carbanolate, carbaryl, carbofuran, carbon disulfide, carbon tetrachloride, carbophenothion, carbosulfan, cartap, chinomethionat, chlorantraniliprole, chlorbenside, chlorbicyclen, chlordane, chlordecone, chlordimeform, chlorethoxyfos, chlorfenapyr, chlorfenethol, chlorfenson, chlorfensulphide, chlorfenvinphos, chlorfluazuron, chlormephos, chlorobenzilate, chloroform, chloromebuform, chloromethiuron, chloropicrin, chloropropylate, chlorphoxim, chlorprazophos, chlorpyrifos, chlorpyrifos-methyl, chlorthiophos, chromafenozide, cinerin I, cinerin II, cismethrin, cloethocarb, clofentezine, closantel, clothianidin, copper acetoarsenite, copper arsenate, copper naphthenate, copper oleate, coumaphos, coumithoate, crotamiton, crotoxyphos, cruentaren A&B, crufomate, cryolite, cyanofenphos, cyanophos, cyanthoate, cyclethrin, cycloprothrin, cyenopyrafen, cyflumetofen, cyfluthrin, cyhalothrin, cyhexatin, cypermethrin, cyphenothrin, cyromazine, cythioate, d-limonene, dazomet, DBCP, DCIP, DDT, decarbofuran, deltamethrin, demephion, demephion-O, demephion-S, demeton, demeton-methyl, demeton-O, demeton-O-methyl, demeton-S, demeton-S-methyl, demeton-S-methylsulphon, diafenthiuron, dialifos, diamidafos, diazinon, dicapthon, dichlofenthion, dichlofluanid, dichlorvos, dicofol, dicresyl, dicrotophos, dicyclanil, dieldrin, dienochlor, diflovidazin, diflubenzuron, dilor, dimefluthrin, dimefox, dimetan, dimethoate, dimethrin, dimethylvinphos, dimetilan, dinex, dinobuton, dinocap, dinocap-4, dinocap-6, dinocton, dinopenton, dinoprop, dinosam, dinosulfon, dinotefuran, dinoterbon, diofenolan, dioxabenzofos, dioxacarb, dioxathion, diphenyl sulfone, disulfiram, disulfoton, dithicrofos, DNOC, dofenapyn, doramectin, ecdysterone, emamectin, EMPC, empenthrin, endosulfan, endothion, endrin, EPN, epofenonane, eprinomectin, esfenvalerate, etaphos, ethiofencarb, ethion, ethiprole, ethoate-methyl, ethoprophos, ethyl-DDD, ethyl formate, ethylene dibromide, ethylene dichloride, ethylene oxide, etofenprox, etoxazole, etrimfos, EXD, famphur, fenamiphos, fenazaflor, fenazaquin, fenbutatin oxide, fenchlorphos, fenethacarb, fenfluthrin, fenitrothion, fenobucarb, fenothiocarb, fenoxacrim, fenoxycarb, fenpirithrin, fenpropathrin, fenpyroximate, fenson, fensulfothion, fenthion, fenthion-ethyl, fentrifanil, fenvalerate, fipronil, flonicamid, fluacrypyrim, fluazuron, flubendiamide, flubenzimine, flucofuron, flucycloxuron, flucythrinate, fluenetil, flufenerim, flufenoxuron, flufenprox, flumethrin, fluorbenside, fluvalinate, fonofos, formetanate, formothion, formparanate, fosmethilan, fospirate, fosthiazate, fosthietan, furathiocarb, furethrin, furfural, gamma cyhalothrin, gamma HCH, glyphosate, gluphosinate, halfenprox, halofenozide, HCH, HEOD, heptachlor, heptenophos, heterophos, hexaflumuron, hexythiazox, HHDN, hydramethylnon, hydrogen cyanide, hydroprene, hyquincarb, imicyafos, imidacloprid, imiprothrin, indoxacarb, iodomethane, IPSP, isamidofos, isazofos, isobenzan, isocarbophos, isodrin, isofenphos, isoprocarb, isoprothiolane, isothioate, isoxathion, ivermectin, jasmolin I, jasmolin II, jodfenphos, juvenile hormone I, juvenile hormone II, juvenile hormone III, lambda-cyhalothrin, lead arsenate, lepimectin, leptophos, lindane, lirimfos, lufenuron, lythidathion, malathion, malonoben, mazidox, mecarbam, mecarphon, menazon, mephosfolan, mercurous chloride, mesulfen, mesulfenfos, metaflumizone, metam, methacrifos, methamidophos, methidathion, methiocarb, methocrotophos, methomyl, methoprene, methoxychlor, methoxyfenozide, methyl bromide, methylchloroform, methylene chloride, methylisothiocyanate, metofluthrin, metolcarb, metoxadiazone, mevinphos, mexacarbate, milbemectin, milbemycin oxime, mipafox, mirex, MNAF, monocrotophos, morphothion, moxidectin, naftalofos, naled, naphthalene, nicotine, nifluridide, nikkomycins, nitenpyram, nithiazine, nitrilacarb, novaluron, noviflumuron, omethoate, oxamyl, oxydemeton-methyl, oxydeprofos, oxydisulfoton, para-dichlorobenzene, parathion, parathion-methyl, penfluron, pentachlorophenol, permethrin, phenkapton, phenothrin, phenthoate, phorate, phosalone, phosfolan, phosmet, phosnichlor, phosphamidon, phosphine, phosphocarb, phoxim, phoxim-methyl, pirimetaphos, pirimicarb, pirimiphos-ethyl, pirimiphos-methyl, potassium arsenite, potassium thiocyanate, pp′-DDT, prallethrin, precocene I, precocene II, precocene III, primidophos, proclonol, profenofos, profluthrin, promacyl, promecarb, propaphos, propargite, propetamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen, quassia, quinalphos, quinalphos-methyl, quinothion, quantiofos, rafoxanide, resmethrin, rotenone, ryania, sabadilla, schradan, selamectin, silafluofen, sodium arsenite, sodium fluoride, sodium hexafluorosilicate, sodium thiocyanate, sophamide, spinetoram, spinosad, spirodiclofen, spiromesifen, spirotetramat, sulcofuron, sulfiram, sulfluramid, sulfotep, sulfur, sulfuryl fluoride, sulprofos, tau fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetradifon, tetramethrin, tetranactin, tetrasul, theta-cypermethrin, thiacloprid, thiamethoxam, thicrofos, thiocarboxime, thiocyclam, thiodicarb, thiofanox, thiometon, thionazin, thioquinox, thiosultap, thuringiensin, tolfenpyrad, tralomethrin, transfluthrin, transpermethrin, triarathene, triazamate, triazophos, trichlorfon, trichlormetaphos-3, trichloronat, trifenofos, triflumuron, trimethacarb, triprene, vamidothion, vaniliprole, XMC, xylylcarb, zeta-cypermethrin and zolaprofos.

The preferred agrochemical active ingredient is a glyphosate salt.

The fertilizers suitable in the agrochemical composition of the invention are, by way of example: ammonia salts such as ammonium sulfate, ammonium bisulfate, ammonium salts of carboxylic acids, ammonium chloride, ammonium carbonate, ammonium phosphate; urea and urea derivatives; phosphate sources, such as phosphoric acid; potash sources, like potassium phosphate (mono- or di-), potassium carbonate; compounds containing micronutrients and secondary nutrients like Zinc, Manganese, Magnesium, Iron, Calcium, Sulfur, Boron, etc; and mixture thereof. Preferred fertilizer is ammonium sulfate.

The agrochemical compositions can be supplied to the farmer in various forms, for instance as neat liquids or powders, granules, aqueous solutions, concentrated suspensions or concentrated emulsions, in combination with other additives having different functions, such as solvents, surfactants, anti-foam agents, anti-freeze agents, colorants, dispersants, stabilisers, preservatives and buffers.

These agrochemical compositions are dissolved/dispersed/diluted before use, usually with water, to provide a diluted agrochemical spray formulation. By diluted formulations we mean formulations typically comprising the active substance(s) in concentration between 0.001 and 50 g/l.

Tamarind (Tamarindus Indica) is a leguminous evergreen tall tree produced in the tropics. Tamarind gum (tamarind powder or tamarind kernel powder), a galactoxyloglucan polysaccharide, is obtained by extracting and purifying the seed powders, obtained by grinding the seeds of tamarind.

Tamarind gum is composed of (1-4)-β-D-glucan backbone substituted with sidechains of α-D-xylopyranose and β-D-galactopyranosyl (1-2)-α-D-xylopyranose linked (1-6) to glucose residues. The glucose, xylose, and galactose units are present in the ratio of 2.8/2.25/1.0. The molecular weight of tamarind gum is within the range of 2.5×10⁵ and 6.5×10⁵. It is water insoluble at room temperature, but forms viscous solutions when heated up. These solutions show an acid and thermal resistance much higher than polygalactomannan solutions, such as guar gum solutions. The procedure for the preparation of a hydroxypropyl tamarind is known in the art, and usually comprises the following steps:
a. tamarind gum is treated with an organic-aqueous alkaline hydroxide and is reacted with propylene oxide;
b. the alkaline hydroxide is neutralized, the possible organic diluent is distilled off and the product obtained is dried, ground and sieved to obtain a hydroxypropyl tamarind derivative.

The hydroxypropyl tamarind of the invention has preferably a molar hydroxypropyl substitution ranging from 0.1 to 2.5, preferably from 0.2 to 1.0.

The HP tamarind may also contain further substituent groups such as carboxyalkyl substituents, wherein the alkyl represents hydrocarbon moiety having 1 to 3 carbon atoms (e.g. carboxymethyl or carboxyethyl) or hydrophobic substituents or combination thereof.

The hydrophobic modification of the HP tamarind of the invention is obtained by the introduction of hydrophobic group.

Typical derivatizing agents bringing a hydrophobic group include C₂-C₂₄ linear or branched alkyl and alkenyl halides or linear, C₆-C₂₄ linear or branched alkyl and alkenyl epoxides and alkyl and alkenyl glycidyl ethers containing a C₄-C₂₄ linear or branched hydrocarbon group.

The hydrophobically modified HP tamarind of the invention may have hydrophobic degree of substitution (DS_{H}) of from 1*10⁻⁵ to 5*10⁻¹, preferably from 1*10⁻⁴ to 1*10⁻¹.

Preferably, the hydrophobically modified HP tamarind of the invention contains as hydrophobic groups C₄-C₂₄ alkyl chains.

Preferably the hydrophobizing agent is a alkyl or alkenyl glycidylether containing a C₄-C₂₄ linear or branched hydrocarbon group.

Halo-carboxylic acids, such as monochloroacetic acid, or their salts can be used for the preparation of carboxyalkyl HP tamarind.

The carboxyalkyl HP tamarind may have a carboxyalkyl DS of from 0.01 to 0.5, preferably from 0.05 to 0.3.

After the preparation, the HP tamarind can be treated with several known reagents, for example: caustic; acids; biochemical oxidants, such as galactose oxidase; chemical oxidants, such as hydrogen peroxide; and enzymatic reagents; or by physical methods using high speed agitation machines; thermal methods; and combinations of these reagents and methods. Reagents such as sodium metabisulfite or inorganic salts of bisulfite may also be optionally included.

The treatments described here above can be also performed on the tamarind gum before the derivatization process.

In a preferred embodiment, the HP tamarind is a depolymerized HP tamarind, which has been depolymerized by using chemicals, such as hydrogen peroxide, or cellulase enzymes.

Advantageously, the HP tamarind can be crosslinked, for example with glyoxal or sodium tetraborate decahydrate, as well know in the art. In fact the crosslinked product obtained, for example, by means of glyoxalation is insoluble at pH lower than 7 and quickly and completely soluble at pH higher than 8; therefore it can be dispersed and dissolved more readily in water.

In a further embodiment, the HP tamarind of the invention is purified by extraction of the impurities with an aqueous or aqueous-organic solvent before a final drying step so as to remove the salts and by-products formed during the reaction. Usually, the purification step takes place after crosslinking.

However, technical grade HP tamarind (i.e. not purified from the reaction by-products) are also suitable for the scope of the invention.

The HP tamarind useful for the present invention has Brookfield viscosity at 20° C., 20 rpm and 5% in water comprised between 500 and 20,000 mPa*s, preferably between 2,000 and 10,000 mPa*s.

Preferably the HP tamarind of the invention is added at a concentration from 0.15 to 0.40% by weight in the diluted agrochemical spray formulation.

The HP tamarind of the invention can be incorporated into the diluted agrochemical spray formulations as solid or can be added as a concentrated liquid formulation. Generally, it is preferred to add the drift control agent of the invention in concentrated liquid form before the addition of the active ingredient(s).

The diluted agrochemical spray formulations of the invention may additionally comprise other conventional additives, including thickeners, flow enhancers, wetting agents, buffers, lubricants, fillers, deposition enhancers, evaporation retardants, frost protecting agents, UV protecting agents, fragrances, anti-foam agents and the like.

The here disclosed diluted agrochemical spray formulations do not require special spraying devices and can be applied on the target area using conventional spray equipments for aerial or ground applications.

### EXAMPLES

### Example 1-4

800 g of tamarind powder were loaded in a 5 litres stirred reactor at room temperature. The reaction atmosphere was made inert by means of vacuum/nitrogen washings, and, under vigorous stirring, 67 g of NaOH dissolved in a water (67 ml)/isopropanol (580 ml) solution were added.

The mixture was maintained under stirring for 15 minutes at 20° C. and then for 1 hour at 70° C. The reactor was cooled at 45° C. and evacuated and refilled three times with nitrogen. Then 100 g of propylene oxide (PO, see Table 1) were slowly added. The reaction mixture was maintained for 60 min at 70-75° C. under stirring.

Afterwards, the reaction mass was cooled down to 40° C. and the pH was adjusted to 6.5-7.0 with phosphoric acid. 36 g of glyoxal (40% wt in water) dissolved in 80 ml of isopropanol were added and the mass was stirred at about 45° C. for 30 minutes. The solvent was distilled and the hydroxypropyl tamarind so obtained was dried on a fluid bed drier using hot air and milled. At the end of the process all the hydroxypropyl tamarind had a moisture content of about 3% by weight (Example 1).

The HP tamarind of Examples 2-4 were prepared according the same procedure varying the amount of propylene oxide (see Table 1). The MS (determined by ¹H-NMR analysis) and RVT Brookfield viscosity (5% wt in water, 20 rpm, 20° C.) of the hydroxypropyl tamarind of Examples 1-4 are reported in the same Table 1.

TABLE 1

| Example | PO (g) | MS | Viscosity mPa*s |
|---|---|---|---|
| 1 | 100 | 0.19 | 1230 |
| 2 | 170 | 0.23 | 970 |
| 3 | 200 | 0.32 | 2750 |
| 4 | 240 | 0.33 | 4590 |

### Example 5

800 g of deoiled tamarind powder were loaded in a 5 litres stirred reactor at room temperature. The reaction atmosphere was made inert by means of vacuum/nitrogen washings, and, under vigorous stirring, 67 g of NaOH dissolved in a water (67 ml)/isopropanol (400 ml) solution were added.

The mixture was maintained under stirring for 15 minutes at 20° C. and then for 1 hour at 70° C. The reactor was cooled at 45° C. and evacuated and refilled three times with nitrogen. 200 g of propylene oxide were slowly added and the reaction mixture was maintained for 60 min at 70-75° C. under stirring.

Afterwards the reaction mass was cooled down to 40° C. and the pH was adjusted to 6.5-7.0 with phosphoric acid. 36 g of glyoxal (40% wt in water) dissolved in 80 ml of isopropanol were added and the mixture was stirred at about 45° C. for 30 minutes. The solvent was distilled and the hydroxypropyl tamarind so obtained was dried on a fluid bed drier using hot air and milled. At the end of the process the hydroxypropyl tamarind had a moisture content of about 3% by weight.

The product so prepared showed an MS of 0.42 (determined by ¹H-NMR analysis) and a RVT Brookfield Viscosity (5% wt in water; 20° C.; 20 rpm) of 6,840 mPa*s.

### Example 6

800 g of tamarind powder were loaded in a 5 litres stirred reactor at room temperature. The reaction atmosphere was made inert by means of vacuum/nitrogen washings, and, under vigorous stirring, 67 g of NaOH dissolved in a water (67 ml)/isopropanol (580 ml) solution were added.

The mixture was maintained under stirring for 15 minutes at 20° C. Then a mixture of 13 g of hydrogen peroxide (80 vol) and 11 g of water was added, the reaction mass was stirred 10 minutes at room temperature, 30 minutes at 40° C. and 60 minutes at 70° C. The reactor was then cooled at 45° C. and evacuated and refilled three times with nitrogen. Then 170 g of propylene oxide were slowly added and the reaction mass was maintained for 60 min at 70-73° C. under stirring.

Afterwards the mass in the reactor was cooled down to 40° C. and the pH was adjusted to 6.5-7 with phosphoric acid. The solvent was distilled and the hydroxypropyl tamarind so obtained was dried on a fluid bed drier using hot air and milled. At the end of the process all the hydroxypropyl tamarind had a moisture content of about 3% by weight.

The product so prepared showed an MS of 0.58 (determined by ¹H-NMR analysis) and a RVT Brookfield Viscosity (7% wt in water; 20° C.; 20 rpm) of 10,150 mPa*s.

Spray Drift Test

A diluted agrochemical spray formulation was prepared by carefully mixing 1% wt of a composition, which simulates a Glyphosate based formulation, containing:
10% Tallow amine ethoxylated (15EO)
90% Water buffered at pH 4.7

with 0.2% wt of HP tamarind of Examples 1-7 and up to 100% wt of Cl PAC D water.

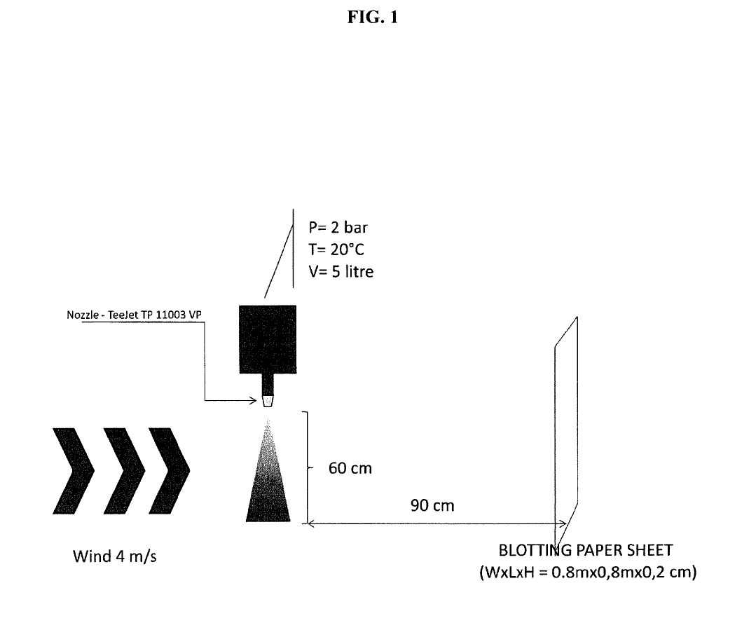

The effect of the anti-drift agent was evaluated in a wind chamber (see FIG. 1) at a temperature of 22° C.±2. The diluted agrochemical spray formulation is pumped at a pressure of 2.0 bar through a Teejet TP 11003 VP nozzle, placed vertically at 60 cm from the floor. An axial fan pulls air through the wind chamber colliding transversally the spray cone at a speed of approximately 4 m/s.

Drifted droplets were collected by a weighted dry paper sheet (W×L×H=1 m×2 m×0.2 cm), placed on the floor at the border of the spray cone. Drift was determined as weight difference within 2 minutes from the collection by weighting the paper sheet after 40 seconds of spraying. All tests were replicated 3 times. The drift reduction is reported as percentage considering 100% the drift of the blank (spray formulation without drift agent).

TABLE 2

| Example | Drift Reduction (%) |
|---|---|
| 1 | 34 |
| 2 | 43 |
| 3 | 21 |
| 4 | 43 |
| 5 | 40 |
| 6 | 40 |

1-8. (canceled)

9. A process for preparing a diluted agrochemical spray formulation with improved drift properties comprising introducing from about 0.10 to about 0.50% by weight (% wt) hydroxypropyl tamarind to the diluted agrochemical spray formulation.

10. The process of claim 9 wherein the diluted agrochemical spray formulation contains one or more pesticides or other crop protection agents chosen from the group consisting of herbicides, fungicides, insecticides, plant growth regulators, fertilizers, and mixtures thereof.

11. The process of claim 9 wherein the hydroxypropyl tamarind is introduced at a concentration of from about 0.15 to about 0.40% wt.

12. The process of claim 9 wherein the hydroxypropyl tamarind has a hydroxypropyl molar substitution of from about 0.1 to about 2.5.

13. The process of claim 12 wherein the hydroxypropyl tamarind has a hydroxypropyl molar substitution of from about 0.2 to about 1.0.

14. The process of claim 9 wherein the hydroxypropyl tamarind is hydroxyphobically modified and has a hydrophobic degree of substitution of from about 1×10⁻⁵ to about 5×10⁻¹.

15. The process of claim 9 wherein the hydroxypropyl tamarind is carboxyalkylated and has a carboxyalkyl degree of substitution of from about 0.01 to about 0.5.

16. The process of claim 10 wherein the one or more pesticides or other crop protection agents is alpha-cypermethrin.

17. The process of claim 10 wherein the one or more pesticides or other crop protection agents is glyphosate salts.

18. The process of claim 10 wherein the one or more pesticides or other crop protection agents is penfluron.

19. A method for treating an agricultural field comprising spraying the field with the diluted agrochemical spray formulation of claim 9.

20. The method of claim 19 wherein the diluted agrochemical spray formulation contains one or more pesticides or other crop protection agents chosen from the group consisting of herbicides, fungicides, insecticides, plant growth regulators, fertilizers, and mixtures thereof.

21. The method of claim 19 wherein the hydroxypropyl tamarind is introduced at a concentration of from about 0.15 to about 0.40% wt.

22. The process of claim 19 wherein the hydroxypropyl tamarind has a hydroxypropyl molar substitution of from about 0.1 to about 2.5.

23. The process of claim 22 wherein the hydroxypropyl tamarind has a hydroxypropyl molar substitution of from about 0.2 to about 1.0.

24. The process of claim 19 wherein the hydroxypropyl tamarind is hydroxyphobically modified and has a hydrophobic degree of substitution of from about 1×10⁻⁵ to about 5×10⁻¹.

25. The process of claim 19 wherein the hydroxypropyl tamarind is carboxyalkylated and has a carboxyalkyl degree of substitution of from about 0.01 to about 0.5.

26. The process of claim 20 wherein the one or more pesticides or other crop protection agents is alpha-cypermethrin.

27. The process of claim 20 wherein the one or more pesticides or other crop protection agents is glyphosate salts.

28. The process of claim 20 wherein the one or more pesticides or other crop protection agents is penfluron.
